(19) United States
(12) Patent Application Publication
(10) Pub. No.: US 2007/0028282 A1
(43) Pub. Date: Feb. 1, 2007

(54) Start up method for a television apparatus

(75) Inventors: Sander R. Kooijmans, Eindhoven (NL); Michiel J. Christianen, Zundert (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 10/571,169

(22) PCT Filed: Sep. 1, 2004
(86) PCT No.: PCT/IB04/51666

§ 371 Date: Mar. 9, 2006

Related U.S. Application Data
(60) Provisional application No. 60/502,314, filed on Sep. 12, 2003.

(51) Int. Cl. H04N 7/173; H04N 7/16

(52) U.S. Cl. 725/132; 725/140

(57) ABSTRACT

A method for use in a television/set-top box (1) for showing video/audio to a viewer prior to the completion of a high level system software boot process (2). The method includes the acts of monitoring said television/set-top box device (1) to detect when the television/set-top box (1) is activated by a user; retrieving meta-data from a storage (20) of the television/set-top box device (1) when the television/set-top box (1) is activated; and using the meta-data to display one or more elementary video/audio streams to the user at a point in time prior to the completion of said high level software boot up process (2). In this manner, a viewer is provided with audio/video substantially from the point of “power on” (soon after an internal driver boot process is complete) rather than having to endure the longer time interval, waiting for the high level system software to become operational. Thus, by displaying video/audio to the viewer soon after the internal driver boot process is complete, the inconvenience and frustration of a viewer having to endure the longer time interval of waiting for the high level system software to become operational without audio/video is overcome.

The present invention relates to an improved digital television/set-top box, and, in particular, to a method and system for digital television/set-top box system initialization.

Generally, when a viewer turns the power on by manipulating a power key (or button), the system software requires on the order of 10 seconds to initialize. After initialization is complete, the television or set-top box can start playing video/audio. One drawback of this process is that a viewer is frustrated by the delay and absence of video with each start up.

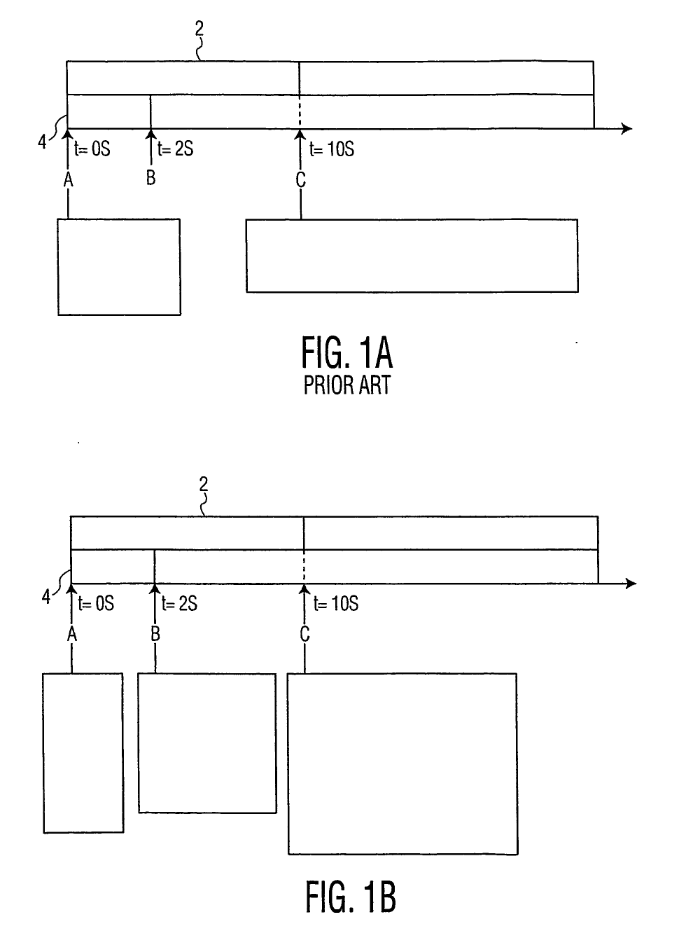

FIG. 1a is a time line illustrating a conventional boot up sequence of a television/set-top box device. At time t=0 (point “A”), the system is powered on. At this time, the high level system software goes through a boot up sequence, i.e., “boot high level software”, generally denoted as element 2. As shown, the high level system software boot sequence 2 generally takes on the order of 10 seconds to complete. During the boot up sequence 2, video/audio is not available to the viewer. Further, the viewer is unable to tune to a desirably selected channel. Control of the system is not relinquished to the viewer until the completion of the boot up sequence 2 at time t=10s, (point C). At this time, the initialization of the high level system software is complete and fully operational. At time t=10s, the viewer gains full control of the television/set-top box device and is able to view video and tune to a desirably selected channel. Also shown in FIG. 1a is the boot up sequence of the system internal drivers, i.e., “boot driver”, generally denoted as element 4. As shown, the driver boot sequence 4 generally takes on the order of 2 seconds to complete (point “B”), at which point the driver is ready for use. It is noted that, while the driver is ready for use at point “B”, the high level software commands the driver to play a specific service at the later time, i.e., point “C”. That is, after the high level software becomes operational.

The present invention takes advantage of the driver's availability at point “B”, prior to the completion of the system boot sequence, point “C”, to play a service and thereby provide video/audio to the viewer prior to the completion of a high level boot process, as will be described below.

In a digital television/set-top box device, a method and system for showing video/audio to a viewer prior to the completion of a system boot process is provided.

A digital television or set-top box is powered on which initiates a high level system software boot process and a concurrent driver boot process. The present invention takes advantage of the fact that the driver boot process completes at an earlier time than the high level system software boot process. The invention adapts the system internal drivers to play audio/video to the viewer at the completion of the driver boot process, as determined by information stored in an EEPROM or FLASH.

According to one aspect of the invention, a method for showing video/audio to a viewer prior to the completion of a high level system software boot process includes the acts of: monitoring the television/set-top box device to detect when the television/set-top box is activated by the user; retrieving meta-data from a storage of the television/set-top box device when the television/set-top box is activated; and using the meta-data to display the one or more elementary video/audio streams to the user at a point in time prior to the completion of the high level software boot up process.

According to another aspect of the invention, a device for showing video/audio to a viewer prior to the completion of a high level system software boot process includes a driver configured to display one or more elementary audio/video streams to a user prior to the completion of a high level software boot up process; and a non-volatile memory for storing meta-data defining the one or more elementary audio/video streams.

The foregoing features of the present invention will become more readily apparent and may be understood by referring to the following detailed description of an illustrative embodiment of the present invention, taken in conjunction with the accompanying drawings, where:

FIG. 1a shows a time line of the boot up sequence of the TV/STB in accordance with the prior art;

FIG. 1b shows a time line of the boot up sequence of the TV/STB in accordance with the present invention; and

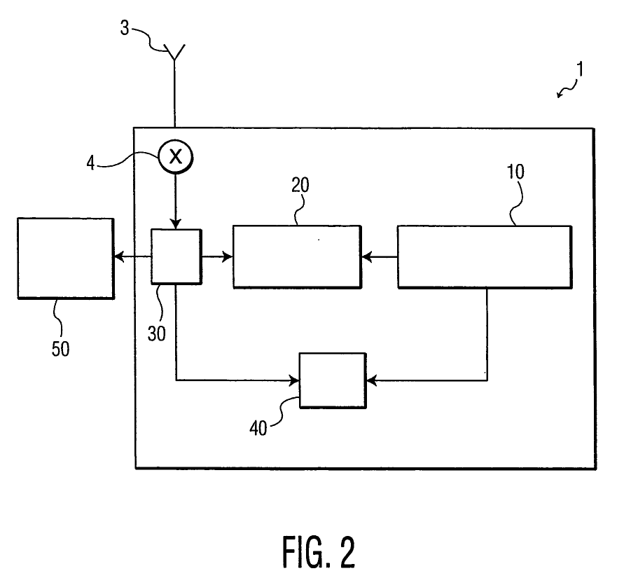

FIG. 2 is an illustration of the hardware components of a TV/STB required to carry out the method of the invention.

In the following detailed description of the present invention, numerous specific details are set forth in order to provide a thorough understanding of the present invention. However, it will be apparent to one skilled in the art that the present invention may be practiced without these specific details. In some instances, well-known structures and devices are shown in block diagram form, rather than in detail, in order to avoid obscuring the present invention.

The software routines of the invention may be described in the general context of computer-executable instructions, such as program modules, being executed by a microprocessor. Generally, program modules include routines, programs, objects, components, data structures, and so forth. Computer storage media defined herein includes but is not limited to SRAM, ROM, FLASH or EEPROMs.

FIG. 2 is a block diagram of various components of a television receiver/set-top box 1 (hereinafter referred to as TV/STB 1) in which the method of the present invention may be performed. It is noted that only those components (modules) are included in FIG. 2 which are considered relevant to the invention. The TV/STB 1 of FIG. 2 includes a tuner 4, a general purpose processor 10, a non-volatile memory 20, a digital signal processor 30 and a random-access memory (RAM 40. The general purpose processor 10 is generally used to run the operating system and the high level software. At least a portion of the internal driver software of the invention runs on general purpose processor 10. FIG. 2 also shows a display apparatus 50 connected to the TV/STB 1 so as to display an image of a TV program and to output a sound. In alternate embodiments, the TV/STB 1 and display apparatus 50 may comprise a single integrated unit.

To more fully appreciate the principles of the invention, the steady state operation of the TV/STB 1 of FIG. 2 is first described. The TV/STB 1 of FIG. 2 is shown connected to an antenna 3 for receiving TV broadcasting signals, which are high frequency radio waves respectively having a predetermined frequency and transmitted from TV stations. When a viewer selects a channel of interest, the tuner 4 tunes to a specific broadcast frequency to receive a transport stream being broadcast on that frequency. As is well known, a transport stream is made up of a number of channels (services), where each channel or service is further comprised of one or more elementary streams. Each of the elementary streams of the transport stream is multiplexed and time-shared with all of the other elementary streams and broadcast at a particular broadcast frequency. The number of channels (services) in a transport stream is mainly limited by the bandwidth of the broadcast network (satellite, terrestrial or cable). Further, each elementary stream of a transport stream is either a video stream, audio stream, teletext stream or data stream.

After the transport stream is tuned (demodulated), the tuner 4 outputs the demodulated transport stream to the DSP 30 be decoded. Subsequent to decoding the transport stream, the DSP 30 separates or divides the elementary streams from the decoded transport stream. The video and audio elementary streams are outputted to the display apparatus 50.

In addition, the DSP 30 extracts service information (DVB-SI) from the decoded transport stream, which is then made available to high level applications by storing it in the RAM 40.

In addition to the acts described above, the TV/STB 1 acquires information (meta-data) identifying the last channel played by the TV/STB 1 when transitioning from either power up to power down or from play to standby mode. The meta-data, once acquired, is preferably stored in the non-volatile memory 20 for subsequent use when the TV/STB next transitions from power down to power up or from standby to play mode.

The meta-data may consist of packet identifiers (pids) of the elementary streams of the channel (service) last played and an identifier of the frequency over which the elementary streams were broadcast. As is well known in the digital TV domain art, each packet in a transport stream has an associated packet identifier (i.e., pid), which associates the packet with an elementary stream. The pid information can be easily extracted from the packets as they arrive and stored in the non-volatile memory 20.

Generally, the invention imposes no restrictions on the form or type of meta-data to be used. It is only required that the meta-data provide sufficient information to enable the TV/STB 1 to play the elementary audio/video streams of the last channel (service) played. Other types of meta-data which may be used by the invention include, for example, service numbers, channel numbers, preset numbers, etc.

FIG. 1b shows a time line of the boot up sequence of the TV/STB 1 in accordance with the present invention. It is to be appreciated that the timelines of FIGS. 1a and 1b are similar in most respects. However, a key distinction between the respective time lines is the recognition that in the time line of FIG. 1b, the internal drivers are adapted to play audio/video at point “B”, the point at which the internal drivers become operational. The present invention takes advantage of the operational readiness of the internal driver so as to display audio/video to a viewer prior to the completion of the high level software boot up process.

The operations of displaying audio/video to a viewer in accordance with the principles of the invention are described now with reference to FIG. 1b.

Point “A” (e.g., t=0s)—is the point in time when the TV/STB 1 is either “powered on” or transitioning from standby to play mode. At point “A”, the internal driver retrieves the meta-data previously stored in the non-volatile memory 20 which identify the last channel played.

Point “B” (e.g., t=2s)—is the point in time when the internal driver becomes operational. In other words, the internal driver boot process is complete. At this point, a viewer is shown one or more elementary video/audio streams associated with the last channel played, as determined from the meta-data retrieved from the non-volatile memory 20. It is noted that the viewer does not have control of the TV/STB1 at this point. At this point, audio/video associated with the last channel played is displayed to the viewer substantially from point “B” to at least point “C”, the point in time when the high level software becomes operational.

Point “C” (e.g., t−10s), the high level system software becomes operational and the user regains full control of the TV/STB 1 and has the option to continue to watch the last channel played or otherwise select audio/video of his or her choice.

In conclusion, the present invention recognizes that the internal drivers become operational at a point in time prior to the operational readiness of the high level software. Thus, the drivers are advantageously adapted to play audio/video to the viewer at this earlier time. In this manner, the viewer is provided with audio/video substantially from the point of “power on” rather than having to endure the longer time interval during which the high level system software transitions towards operational readiness. Thus, the inconvenience and frustration of a viewer having to endure the longer time interval without any audio/video is overcome.

The foregoing is to be constructed as only being an illustrative embodiment of this invention. Persons skilled in the art can easily conceive of alternative arrangements providing a functionality similar to this embodiment without any deviation from the fundamental principles or the scope of this invention.

1. A method for displaying one or more elementary audio/video streams to a user prior to the completion of a high level software boot up process (2) in a television/set-top box device (1), the method comprising the acts of:
monitoring said television/set-top box device (1) to detect when said television/set-top box is activated by the user;
retrieving meta-data from a storage (20) of the television/set-top box device (1) when said television/set-top box is activated; and
using said meta-data to display said one or more elementary video/audio streams to the user at a point in time prior to the completion of said high level software boot up process (2).

2. The method of claim 1, wherein said one or more elementary video/audio streams are displayed to the user at a point in time substantially equal to the completion of an internal driver boot up process (4).

3. The method of claim 1, wherein said monitoring act includes the act of detecting a switch from one of a power down to a power up mode (“A”) and detecting a switch from a standby mode to a play mode (“A”).

4. The method of claim 1, wherein said meta-data defines at least said one or more elementary audio/video streams and a broadcast frequency corresponding to said one or more elementary audio/video streams.

5. The method of claim 1, prior to said monitoring act, performing the acts of:
monitoring said television/set-top box device (1) to detect when said television/set-top box (1) is de-activated by the user; and
storing said meta-data when said television/set-top box (1) is de-activated.

6. The method of claim 5, wherein said monitoring act includes the act of detecting a switch from one of a power up to a power down mode and detecting a switch from a play mode to a standby mode.

7. A television/set-top box display apparatus (1), comprising an internal driver configured to display one or more elementary audio/video streams to a user prior to the completion of a high level software boot up process (2); and a non-volatile memory (20) for storing meta-data defining said one or more elementary audio/video streams.

8. The television/set-top box display apparatus of claim 7, wherein the non-volatile memory is one of an EEPROM memory and a FLASH memory.

9. The television/set-top box display apparatus of claim 7, wherein the internal driver is configured via computer code.

10. The television/set-top box display apparatus of claim 9, wherein the computer code is written in the Java programming language and in the C++ programming language.
